(19) United States
(12) Patent Application Publication
(10) Pub. No.: US 2025/0062481 A1
(43) Pub. Date: Feb. 20, 2025

(54) BATTERY MODULE

(71) Applicants: HYUNDAI MOTOR COMPANY, Seoul (KR); KIA CORPORATION, Seoul (KR)

(72) Inventors: Hyun Chang Kang, Seoul (KR); Ji Woong Jung, Anyang-si (KR); Yu Ri Oh, Hwaseong-si (KR); Jun Young Kang, Hwaseong-si (KR); Sun Keun Park, Seoul (KR); Byung Su Kim, Incheon (KR); In Gook Son, Incheon (KR)

(73) Assignees: HYUNDAI MOTOR COMPANY, Seoul (KR); KIA CORPORATION, Seoul (KR)

(21) Appl. No.: 18/605,367

(22) Filed: Mar. 14, 2024

(30) Foreign Application Priority Data
Aug. 14, 2023 (KR) 10-2023-0106340

(51) Int. Cl. H01M 50/342; H01M 50/204; H01M 50/249; H01M 50/293

(52) U.S. Cl. CPC H01M 50/342; H01M 50/204; H01M 50/249; H01M 50/293; H01M 2220/20

(57) ABSTRACT

A battery module includes a plurality of overlapped battery cells and an insert panel inserted between the overlapped battery cells. The battery module further includes a top flange extended in an overlapping direction of the battery cells above the battery cells.

### CROSS REFERENCE TO RELATED APPLICATION

The present application claims priority to Korean Patent Application No. 10-2023-0106340, filed Aug. 14, 2023, the entire contents of which is incorporated herein for all purposes by this reference.

### BACKGROUND

### Technical Field

The disclosure relates to a structure of a battery module mounted to a battery pack or the like of a vehicle.

### Description of the Related Art

An electric vehicle, a hybrid vehicle, or the like includes a motor that is driven by electricity to generate a driving force for the vehicle.

To stably supply electric power to the motor, the vehicle includes a battery pack, which includes a plurality of battery modules. Each battery module includes a plurality of overlapped battery cells.

It has been reported that an abnormal phenomenon such as a fire breaks out in the battery cells making up the battery module. In this case, a thermal runaway phenomenon occurs due to flames spreading to neighboring battery cells and neighboring battery modules.

The subject matter described as the related art is merely intended to help understand the background of the disclosure. The above should not be accepted as recognition of the prior art that has already been known to a person of ordinary skill in the art.

### SUMMARY

An aspect of the disclosure is to provide a battery module in which flames, conductive materials, gases, and the like, are effectively vented to the outside when a fire or the like breaks out in a battery cell, and in which heat is effectively prevented from being transferred to neighboring battery cells.

According to an embodiment of the disclosure, a battery module includes a plurality of overlapped battery cells and an insert panel inserted between the overlapped battery cells. The insert panel further includes a top flange extended in an overlapping direction of the battery cells above the battery cells.

The top flange of the insert panel may be disposed to be spaced upwardly apart from a top of the battery cell.

The insert panel may include a partition inserted between two adjacent battery cells and the top flange extending from a top of the partition.

A bottom of the partition of the insert panel may be installed to be inserted into a gap filler below the battery cells.

The top flange may be formed to have a shape extending from the partition toward one side.

The battery module may include a plurality of insert panels. The top flanges of the plurality of insert panels may all be arranged to face in one direction.

The battery module may further include an intermediate panel between the battery cells between the two insert panels, wherein a top of the intermediate panel protrudes more upwardly than the top of the battery cell and is positioned lower than the top flange of the two insert panels.

The top flange may be formed to have a shape extending from the partition toward both sides.

The top flange may be extended in a range of more than 50% but less than 100% of a width from its own partition to another partition of the adjacent insert panel.

The insert panel may include metal.

The battery module may further include a battery module cover disposed above the top flange of the insert panel and covering an upper side of the entire battery module.

The battery module cover may be installed to be spaced upwardly apart from the top flanges of the insert panels.

A distance at which the battery module cover is spaced apart from the top flanges of the insert panels may be less than or equal to an extended width of the top flange of the insert panel.

The insert panel may include a fireproof material.

The insert panel may include metal. The partition of the insert panel may be overlapped with a silicone or fireproof polyurethane (PU).

The insert panel may include a plurality of insert panels. The top flanges provided in the plurality of insert panels may all be disposed at the same height.

According to the disclosure, flames, conductive materials, gases, and the like, are effectively vented to the outside when a fire or the like breaks out in a battery cell. Heat is also effectively prevented from being transferred to neighboring battery cells.

### BRIEF DESCRIPTION OF THE DRAWINGS

FIG. 1 is a view depicting a battery module according to the disclosure.

FIG. 2 is a cross-sectional view taken along line II-II of FIG. 1.

FIG. 3 is a view illustrating that a fire breaks out at a battery cell in a battery module of FIG. 1.

FIG. 4 is a cross-sectional view taken along line IV-IV of FIG. 3.

FIG. 5 is a view depicting an embodiment with a battery module cover.

FIG. 6 is a view depicting another embodiment with a battery module cover.

FIG. 7 is a view depicting another embodiment of a battery module according to the disclosure.

FIG. 8 is a view illustrating that a fire breaks out at a battery cell in a battery module of FIG. 7.

### DETAILED DESCRIPTION

Hereinafter, embodiments of the disclosure are described in detail with reference to the accompanying drawings, in which the same or similar elements are denoted by the same reference numerals even though they are depicted in different drawings. Redundant descriptions thereof have been avoided.

Suffixes such as “module” and “unit” that follow elements in the following description are given in consideration only for ease of description and do not have meaning or functions discriminated from each other.

In terms of describing embodiments of the disclosure, detailed descriptions of the related art have been omitted where such descriptions may have made the subject matter of the embodiments of the disclosure unclear. In addition, the accompanying drawings are provided only for a better understanding of the embodiments of the disclosure and are not intended to limit the technical ideas of the disclosure. Therefore, it should be understood that the accompanying drawings include all modifications, equivalents and substitutions within the scope and sprit of the disclosure.

Terms such as “first” and “second” may be used to describe various components, but the components should not be limited by the above terms. In addition, the above terms are used only to distinguish one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components are not disposed between the one component and other component.

Unless the context clearly dictates otherwise, singular forms include plural forms as well.

In the disclosure, it should be understood that the terms “include” or “have” and variations thereof indicate that a feature, a number, a step, an operation, an element, a part, or the combination thereof described in the embodiments is present. These terms do not preclude a possibility of the presence or addition of one or more other features, numbers, steps, operations, elements, parts or combinations thereof. When a component, device, element, or the like of the present disclosure is described as having a purpose or performing an operation, function, or the like, the component, device, or element should be considered herein as being “configured to” meet that purpose or to perform that operation or function.

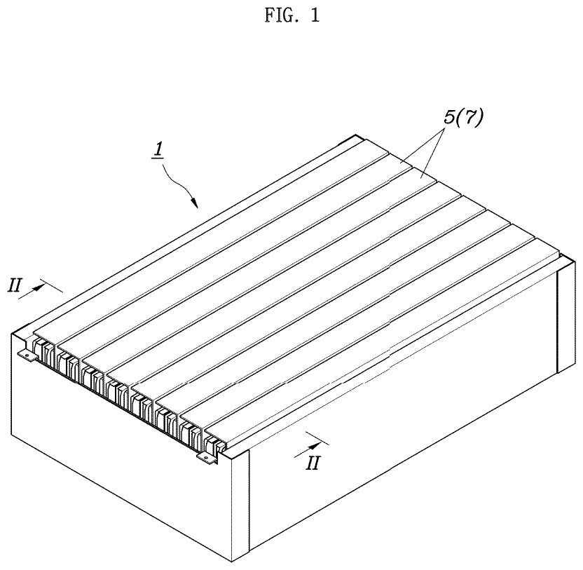

Referring to FIGS. 1-8, a battery module 1 according to the disclosure includes a plurality of overlapped battery cells 3 and an insert panel 7. The insert panel 7 is inserted between the overlapped battery cells 3 and has a top flange 5 extending in an overlapping direction of the battery cells 3 above the battery cells 3.

In other words, the battery module 1 according to the disclosure includes the insert panel 7 provided between the 5 battery cells 3 arranged to overlap each other. The top flange 5 is provided at the top of the insert panel 7.

Specifically, the insert panel 7 includes a partition 9 inserted between two adjacent battery cells 3. The top flange 5 extends from the top of the partition 9.

In other words, as shown therein, the partition 9 of the insert panel 7 is inserted between the battery cells 3 making up the battery module 1. The top flange 5 of the insert panel 7 is disposed above the battery cells 3.

Therefore, the top flanges 5 of the insert panels 7 make up a kind of protective wall above the battery cells 3 of the battery module 1. Thus, it is not necessary to additionally provide a component for covering the upper side of the battery module 1.

Here, the top flange 5 of the insert panel 7 is disposed to be spaced upwardly apart from the top of the battery cells 3.

Thus, when a fire or the like breaks out in any of the battery cells 3 making up the battery module 1, flames, conductive materials, gases, and the like, are smoothly dischargeable through a space between the top of those battery cells 3 and the top flange 5.

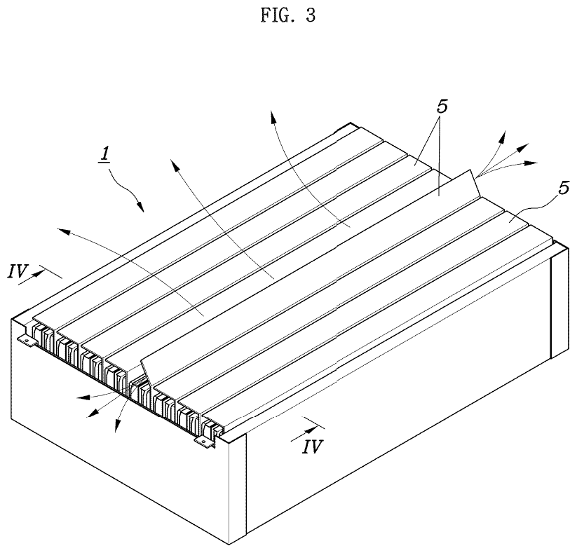

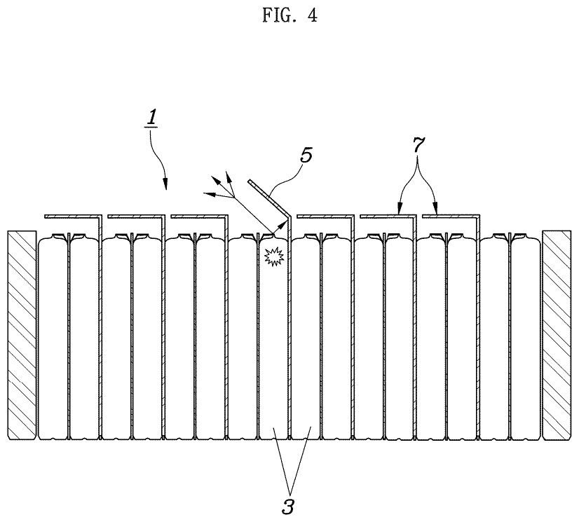

Further, even when the top flange 5 disposed above those battery cells 3 are deformed upwards as shown in FIGS. 3 and 4 due to the explosion or the like of the foregoing abnormal battery cells 3, the flames, conductive materials, gases, and the like, are smoothly dischargeable to the outside as shown therein and blocked so as not to be transmitted to other neighboring battery cells. A thermal runaway phenomenon of the battery module 1 is thereby effectively prevented.

The bottom of the partition 9 of the insert panel 7 may be installed to be inserted into a gap filler 11 below the battery cells 3.

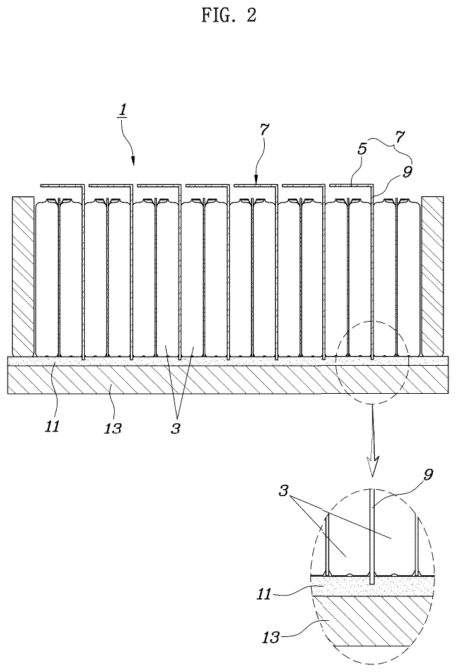

As shown in FIG. 2, a cooling channel 13 or other type of like cooling unit may be provided beneath the gap filler 11. Thus, heat transferred from the battery cells 3 through the partition 9 of the insert panel 7 can be more effectively dissipated through the gap filler 11.

In other words, the structure where the bottom of the partition 9 is inserted in the gap filler 11 causes the gap filler 11 to serve as a heat transfer medium more smoothly. Thus, heat generated in the battery cells 3 making up the battery module 1 can be easily transferred to the cooling channel 13 through the partition 9 of the insert panel 7. The durability of the battery cells 3 of the battery module 1 is thereby improved.

For reference, the cooling channel 13 may be configured to cool the battery cells 3 of the battery module 1 while allowing coolant or the like to flow therein.

In FIGS. 1-6, the top flange 5 is formed to have a shape extending from the partition 9 toward one side of the battery module 1.

Further, the top flanges 5 of the plurality of insert panels 7 are all arranged to face in the same direction.

In other words, as shown therein, the insert panel 7 has a cross-section shaped like an inverted L-shape. The insert panels 7 are regularly arranged between the battery cells 3, in which all the top flanges 5 are disposed to face in one direction.

If one or more top flanges 5 are disposed in the opposite direction to the other top flanges 5, the battery cells 3 between the two insert panels 7 are not isolated from each other. Thus, a fire that breaks out in one of those battery cells 3 may readily spread to the adjacent battery cells 3.

There may be a plurality of insert panels 7 and the top flanges 5 provided in the plurality of insert panels 7 are all disposed at the same height.

Further, the top flange 5 is extended in a range of more than 50% but less than 100% of a width from its own partition 9 to another partition 9 of the adjacent insert panel 7.

In other words, more than half or almost all of the upper surfaces of the battery cells 3 are covered with the top flanges 5. Thus, the top flanges 5 of the plurality of insert panels 7 can serve as a protective wall surrounding the upper side of the battery module 1.

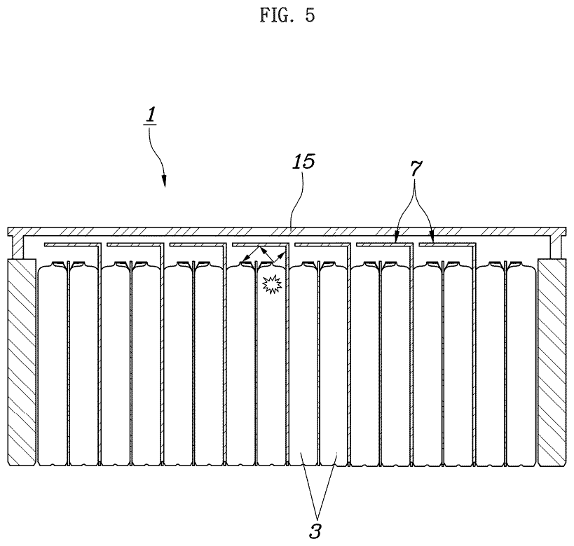

Of course, even in the battery module 1 provided with the foregoing insert panels 7, as shown in FIG. 5 a battery module cover 15 that covers the upper side of the entire battery module 1 may be installed above the top flanges 5 of the insert panels 7.

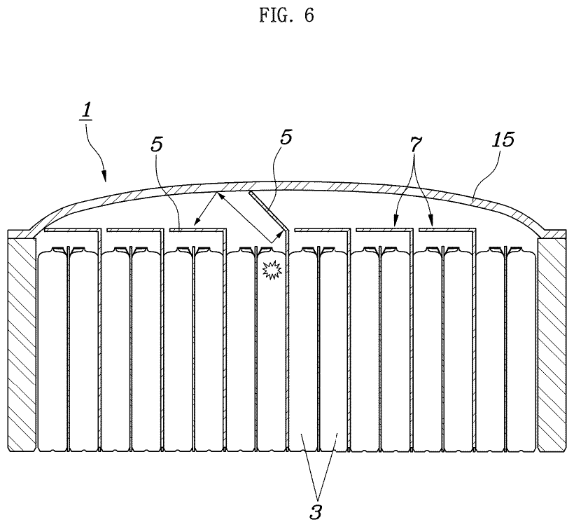

The battery module cover 15 may be installed to be spaced upwardly apart from the top flanges 5 of the insert panels 7 or may be deformed to be spaced upwardly apart from the top flanges 5 as shown in FIG. 6 due to the thermal runaway phenomenon of the battery module 1.

In this case, a distance at which the battery module cover 15 is spaced apart from the top flanges of the insert panels 7 may be less than or equal to the width by which the top flange 5 of the insert panel 7 is extended.

In other words, when the distance at which the battery module cover 15 is spaced apart from the top flange 5 of the insert panel 7 is less than or equal to the width by which the top flange 5 of the insert panel 7 is extended from the partition 9, the end of the top flange 5 comes into close contact with the lower surface of the battery module cover 15 and serves to partition the inner space of the battery module 1. This may greatly contribute to preventing a fire from spreading to the other battery modules 1 even though the fire or the like breaks out in any of the battery cells 3 and cause the top flange 5 disposed above that battery cell 3 to be deformed upwards as shown in FIG. 6.

The insert panel 7 may be made of metal such as iron or aluminum.

In this case, as shown in FIG. 2, the bottom of the partition 9 of the insert panel 7 is inserted in the gap filler 11 on the cooling channel 13, thereby having the maximum effect on cooling the battery cells 3.

The insert panel 7 may be made of a fireproof material such as mica or ceramic.

In this case, the foregoing cooling effect may be slightly decreased, but all the technical effects may be obtained as the insert panel 7 having the top flange 5 as described above is provided between the battery cells 3.

Further, the insert panel 7 may be made of metal and the partition 9 of the insert panel 7 may have an overlapping structure of silicone or fireproof polyurethane (PU).

In other words, when silicone is overlapped on the partition 9, it may be more advantageous to maintain surface pressure distribution evenly between the battery cells 3. When the fireproof PU is overlapped on the partition 9, an insulation effect between the battery cells 3 may be further improved.

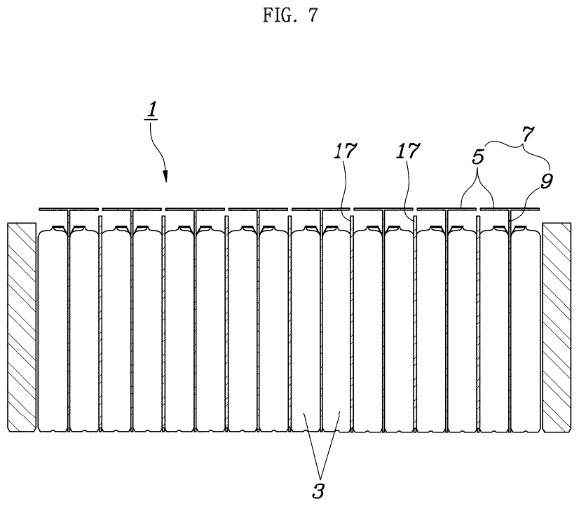

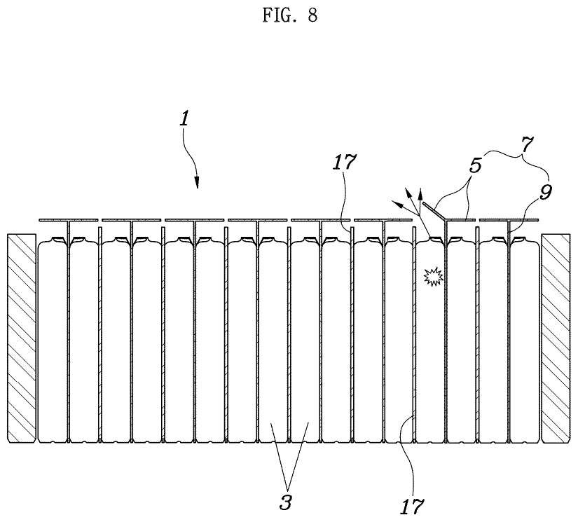

FIGS. 7 and 8 show other embodiments of the disclosure in which the top flange 5 of the insert panel 7 is formed to have a shape extending from the partition 9 toward both sides or opposed sides of the battery module 1.

In this case, the top of an intermediate panel 17 disposed between the battery cells 3 and between the two insert panels 7 protrudes more upwardly than the top of the battery cells 3 as shown therein. The top of the intermediate panel 17 is positioned lower than the top flange 5 of the two insert panels 7. Thus, the isolation between the battery cells 3 can be made more effective when a fire or the like breaks out in any of the battery cells 3.

For reference, the arrows in the accompanying drawings represent the movement of the flames, conductive materials, gases, and the like that may be generated in the battery cells 3 in the event of a fire or the like.

Although specific embodiments of the disclosure have been illustrated and described above, various modifications and changes can be made by a person of ordinary skill in the art without departing from the scope of technical ideas defined by the appended claims.

What is claimed is:

1. A battery module comprising:
a plurality of overlapped battery cells; and
an insert panel inserted between the overlapped battery cells, the insert panel including a top flange extended in an overlapping direction of the battery cells above the battery cells.

2. The battery module of claim 1, wherein the top flange of the insert panel is disposed to be spaced upwardly apart from a top of the battery cell.

3. The battery module of claim 2, wherein the insert panel further comprises:
a partition inserted between two adjacent battery cells; and
the top flange extending from a top of the partition.

4. The battery module of claim 3, wherein a bottom of the partition of the insert panel is inserted into a gap filler below the battery cells.

5. The battery module of claim 3, wherein the top flange has a shape extending from the partition toward one side of the battery module.

6. The battery module of claim 5, wherein the battery module further comprises a plurality of the insert panels, and wherein the top flanges of the plurality of the insert panels are all arranged to face in one direction.

7. The battery module of claim 3, wherein the top flange has a shape extending from the partition toward both of opposed sides of the battery module.

8. The battery module of claim 7, further comprising an intermediate panel between the battery cells and between two of the insert panels,
wherein a top of the intermediate panel protrudes more upwardly than the top of the battery cell and is positioned lower than the top flange of the two insert panels.

9. The battery module of claim 3, wherein the top flange is extended in a range of more than 50% but less than 100% of a width from its own partition to another partition of the adjacent insert panel.

10. The battery module of claim 4, wherein the insert panel further comprises metal.

11. The battery module of claim 3, further comprising a battery module cover disposed above the top flange of the insert panel and covering an upper side of the entire battery module.

12. The battery module of claim 11, wherein the battery module cover is spaced upwardly apart from the top flange of the insert panel.

13. The battery module of claim 12, wherein a distance at which the battery module cover is spaced apart from the top flange of the insert panel is less than or equal to an extended width of the top flange of the insert panel.

14. The battery module of claim 3, wherein the insert panel further comprises a fireproof material.

15. The battery module of claim 3, wherein the insert panel further comprises metal, and wherein the partition of the insert panel is overlapped with a silicone or fireproof polyurethane (PU).

16. The battery module of claim 3, wherein the insert panel further comprises a plurality of the insert panels, and wherein the top flanges provided in the plurality of insert panels are all disposed at the same height.
